(19) United States
(12) Patent Application Publication
(10) Pub. No.: US 2008/0268397 A1
(43) Pub. Date: Oct. 30, 2008

(54) Method and System for Temporary Skeletal Anchorage in Orthodontics

(76) Inventor: John W. Graham, Phoenix, AZ (US)

Correspondence Address: WOOD, HERRON & EVANS, LLP, 2700 CAREW TOWER, 441 VINE STREET, CINCINNATI, OH, 45202, US

(21) Appl. No.: 12/090,730

(22) PCT Filed: Oct. 19, 2006
(86) PCT No.: PCT/US2006/041150

§ 371 Date: Apr. 18, 2008

Related U.S. Application Data
(60) Provisional application No. 60/729,065, filed on Oct. 20, 2005.

(51) Int. Cl. A61C 3/00; A61C 7/02; A61C 8/00

(52) U.S. Cl. 433/3; 433/174; 433/24

(57) ABSTRACT

A driver device (10) inserts orthodontic miniscrews for orthodontic procedures. The driver device (10) has a handle portion (12) for gripping by an orthodontic professional and a driver (20) for applying a predetermined torque to an orthodontic miniscrew. The handle portion (12) includes a plurality of displays for providing a variety of feedback concerning the operation of the device and a plurality of controls to control operation of the device. Indicia, such as color indicators, on the orthodontic screws and the driver device (10) correspond to particular zones on the patient's skull and jaw where the orthodontic screw maybe implanted, as correlated by an atlas of the skull and jaw utilizing corresponding indicia.

This is related to provisional patent application Ser. No. 60/729,065 filed on Oct. 20, 2005, the disclosure of which is hereby fully incorporated by reference herein.

### TECHNICAL FIELD

The technical field discussed is orthodontics. In particular, a system and method for temporary skeletal anchorage in orthodontics is discussed.

### BACKGROUND

In traditional tooth movement, orthodontic brackets are placed on the teeth, and the brackets are connected to one another using an orthodontic archwire. The orthodontic archwire transfers tooth-moving forces to certain teeth, using other teeth as anchors. However, this traditional method of tooth movement has several potential shortcomings or drawbacks. For example, in some patients, the tooth or teeth desirable for use as an anchor are missing. Furthermore, although a particular tooth is serving as an anchor for generating an orthodontic force, there also is a counter-force exerted on the “anchor” tooth causing undesirable movement or migration of the anchor tooth.

Orthodontic miniscrews avoid these drawbacks, as the miniscrew is placed directly into the jaw or skull of the patient. The miniscrew therefore provides an anchor that does not migrate, unlike using a tooth as an anchor. Accordingly, miniscrew use is rapidly increasing as the anchor of choice in the orthodontic market.

Drawbacks, however, still exist in the use of miniscrews as orthodontic anchors. One common drawback is implantation of the miniscrew into the jaw or skull. Manual implantation using a tool to drive the miniscrew can lead to damage to the jaw or skull since the dental professional can apply too much torque or pressure to the miniscrew during implantation. In addition, many automatic miniscrew implantation devices can excessively torque the miniscrew leading to stripping of the threads created by the screw in the bone in the jaw or skull. Furthermore, the application of too much pressure to the miniscrew during implantation can result in damage to the bone. Another common drawback is the difficulty in organizing miniscrews for proper selection. Different areas of the skull and jaws have different bone densities, covering tissue type and tissue depth, and therefore different screw designs and/or sizes are necessary. Ensuring that the correct miniscrew is used in the correct location in the skull or in the jaw is essential, but can be difficult due to the small size of the miniscrews. Accordingly, needs exist in this area of technology.

### SUMMARY

One aspect of the invention is a device for placing orthodontic temporary anchorage miniscrews into a patient's mouth. The device includes a handle portion constructed and arranged for handling by a human hand. The handle portion includes a plurality of controls to control operation of the device and one or more displays for providing feedback concerning the operation of the device, including feedback regarding the torque and pressure applied to the miniscrew during insertion. The handle portion further includes a driver that connects or mates to the miniscrew and rotates for implanting the miniscrew into the patient's mouth.

Another aspect is a method for implanting an orthodontic temporary anchoring miniscrew into the mouth of a patient. The method includes the steps of obtaining a driver device for implanting a preselected miniscrew into the mouth of the patient. The method further includes setting a maximum level of torque for application to the miniscrew using a torque limiter in connection with the device. The method also includes the steps of implanting the miniscrew into the mouth of the patient using the device and monitoring the pressure applied to the miniscrew during the implanting of the miniscrew.

A further aspect of the invention is a device for implanting a miniscrew, wherein the device includes a driver having a torque limiting function with a plurality of predetermined torque outputs each associated with an indicator. The device also includes a plurality of orthodontic miniscrews each having a distinct indicator corresponding to the indicators on the driver device. The torque output of the driver device for a certain indicator matches the optimal torque profile for a miniscrew having the same indicator.

Yet another aspect of the invention includes a system for organizing orthodontic miniscrews for selection of the proper miniscrew prior to insertion into the mouth of a patient. The system includes a first plurality of miniscrews associated with a first indicium, one non-limiting example of which is a first color indicator, and a second plurality of miniscrews associated with a second indicium, one non-limiting example of which is a second color indicator. While two or more colors may be suitable indicia, other suitable indicia may include letters, numbers, symbols or other indicia. Without intending to limit the invention to color indicia, the invention will be further described with a generic reference to “indicium” or “indicia” and also specific reference to “color” or “color indicium” or “color indicia” or “color indicator.” In the general sense, “indicium” and “indicia” are intended to be broader than the specific reference to “color” or “color indicium” or “color indicia” or “color indicator.”

In one advantageous embodiment, the first indicia/color indicator and the second indicia/color indicator reference predetermined zones of the jaw and skull as correlated by an atlas of the skull and jaw having corresponding indicia/color indicator zones. The indicia or color correlation between the miniscrews and the skull and jaw atlas may be based upon one or more of the following parameters: for the miniscrews, screw length, screw diameter, screw head shape, length of transmucosal collar, inclusion of cutting flutes, screw thread characteristics (e.g., pitch, count and angulation), screw head height (height of emergence of screw), and surface treatments/coatings dependent upon the length of time the screw is intended to remain in the mouth of the patient (i.e., to encourage or discourage osseointegration); for the region in the patient, bone density, covering tissue type and tissue depth; and for the driver device, torque to be applied to the screw and pressure to be applied to the screw. It will be appreciated that there may be more than just a first and second indicia or color indicator and correlated indicia or color cones in the jaw and skull atlas. That is, there may be three or more different indicia or color indicators and correlated zones.

An additional aspect of the invention is a driver device for inserting orthodontic miniscrews into the mouth of a patient. The driver connects to and rotates the orthodontic miniscrew. The driver device also includes a handle constructed and arranged for gripping by a human hand and a light array placed along the handle. The light array responds to the level of pressure applied to the orthodontic miniscrew by the driver. The dial is placed along the handle portion and adjustment of the dial limits the maximum amount of torque applied to the orthodontic miniscrew by the driver. The device also includes a governor for controlling the revolutions per minute of the driver and a finger switch operatively coupled to the handle portion at least controlling the direction of rotation of the driver.

A further aspect is a system for implanting orthodontic miniscrews in the mouth of a patient. The system includes a first plurality of miniscrews corresponding to a first zone in the patient's mouth and having a first indicium or color indicator. The system also includes a second plurality of miniscrews corresponding to a second zone in the mouth of the patient and having a second indicium or color indicator. There may be additional pluralities of miniscrews corresponding to additional zones in the patient's mouth and having additional indicia or color indicators. The system further includes driver devices for implanting the miniscrews into the mouth having corresponding indicia or color indicators for setting the torque and pressure during implantation, the indicia or color indicators corresponding to the amount of torque needed for placing the plurality of miniscrews according to the corresponding color indicator.

### BRIEF DESCRIPTION OF THE DRAWINGS

These and other features, aspects, and advantages of the present invention will become better understood with regard to the following description, appended claims and accompanying drawings wherein:

FIG. 1 illustrates a perspective view of a driver device for driving orthodontic miniscrews into the jaw or skull of a patient according to one embodiment;

FIG. 2A illustrates a front elevational view of a human skull having different zones with different colors marked on the skull and jaw indicating locations for placing different orthodontic screws;

FIG. 2B illustrates a side elevational view of the human skull of FIG. 2A;

FIG. 2C illustrates a perspective view of the human skull of FIG. 2A;

FIG. 2D is a top elevational view of the jaw of the human skull of FIG. 2A illustrating the different zones inside of the bottom of the jaw bone; and

FIG. 3 is a perspective view of an exemplary orthodontic miniscrew according to the present invention.

### DETAILED DESCRIPTION OF THE DRAWINGS

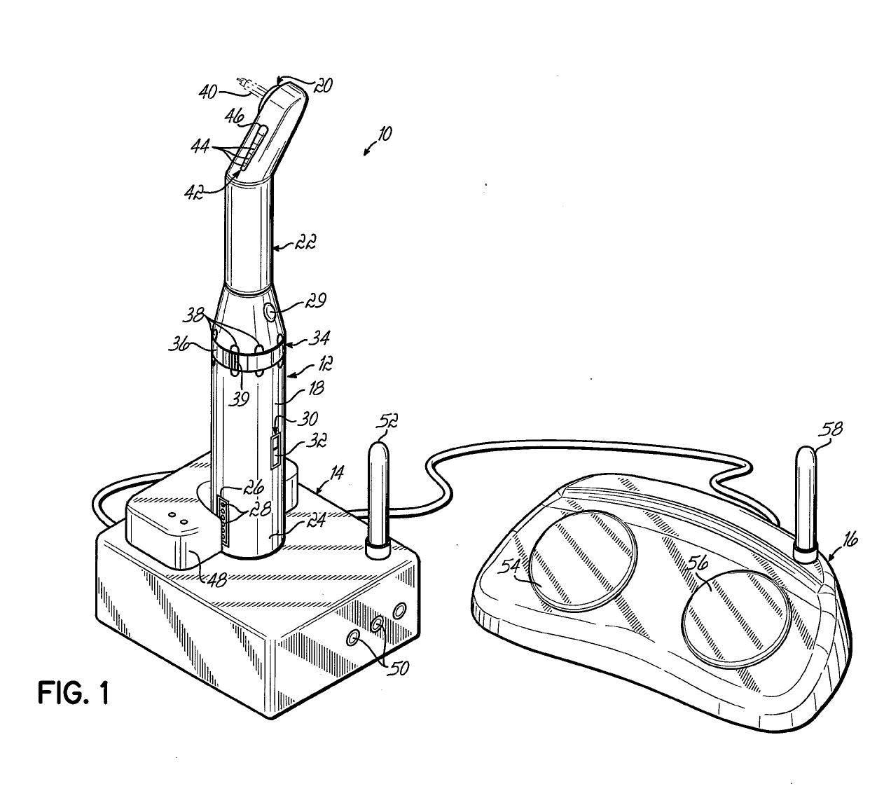

Referring now to the drawings, FIG. 1 illustrates a driver device 10 for driving orthodontic screws into the jaw or skull of a patient. The driver device 10 includes a handle portion 12 for gripping by the clinician, a charging base 14 for receiving and charging the handle portion 12, and an optional foot pedal 16 operatively coupled to the charging base 14 and/or the driver device 10 for at least partially controlling operation of the driver device 10. The driver device 10 may be powered by any one of a number of sources, such as electrical energy, fuel cell, or other energy sources readily apparent to those skilled in this art.

The handle portion 12 includes a grip 18 for gripping by the clinician during operation of the handle portion 12, a driver 20 for applying a torque to an orthodontic miniscrew, and a neck portion 22 that connects the grip 18 to the driver 20. The grip 18 in the illustrated embodiment is formed of a plastic material, however, other types of materials may be used such as metal or the like. The handle portion 12 is sterilizable. The grip 18 in the illustrated embodiment is generally in the shape of a circular cylinder to conform to the shape of a user's hand, however, other suitable structures such as a square rod can be used. The grip 18 includes a plurality of different control features located upon an outer surface 24. The first control feature is a charge indicator 26 indicating the amount of power remaining in the power source (not shown) located inside of the grip 18. The power source (not shown) in the illustrated embodiment is an electrical battery, however, fuel cells or other types of power sources can be used.

In the illustrated embodiment, the charge indicator 26 has a plurality of individual lights 28 that sequentially illuminate providing an indication of the level of electric charge or energy remaining in the power source located in the handle portion 12. For instance, if there are ten individual lights 28 and five are illuminated then the handle portion 12 still contains approximately fifty percent of the potential maximum energy. Of course, upon reading this specification, those skilled in this art will readily recognize that a myriad of alternatives for indicating the amount of remaining energy are available for use in other potential embodiments, such as a numerical display, changing color of light, and an auditory signal to name a few. The grip 18 also includes a power button 29 for turning the driver 20 on and off and a finger switch 30 for controlling the direction of rotation of the driver 20 when it is turned on. The finger switch 30 acts as an alternative to the foot pedal 16 as a way to control the direction of torque applied by the driver 20. In the illustrated embodiment, the finger switch 30 is a panel 32 movable along the outer surface 24 of the grip 18 in opposing directions that correspond to the direction of rotation of the driver 20 and torque applied to the orthodontic screw. Other designs control the power-on and direction of rotation and torque applied by the driver 20 using other control configurations that, upon reading this specification, will be readily apparent to those skilled in this art. The grip 18 also includes a torque limiter 34 for limiting the amount of torque that the driver 20 can apply to an orthodontic screw. In the illustrated embodiment, the torque limiter 34 adjusts the driver 20 to the proper maximum torque automatically to prevent the torque applied to the miniscrew from exceeding a predetermined maximum threshold. Torque limiters are well known in the art. The dental professional manipulates the handle portion 12 driving an orthodontic screw into the patient's mouth.

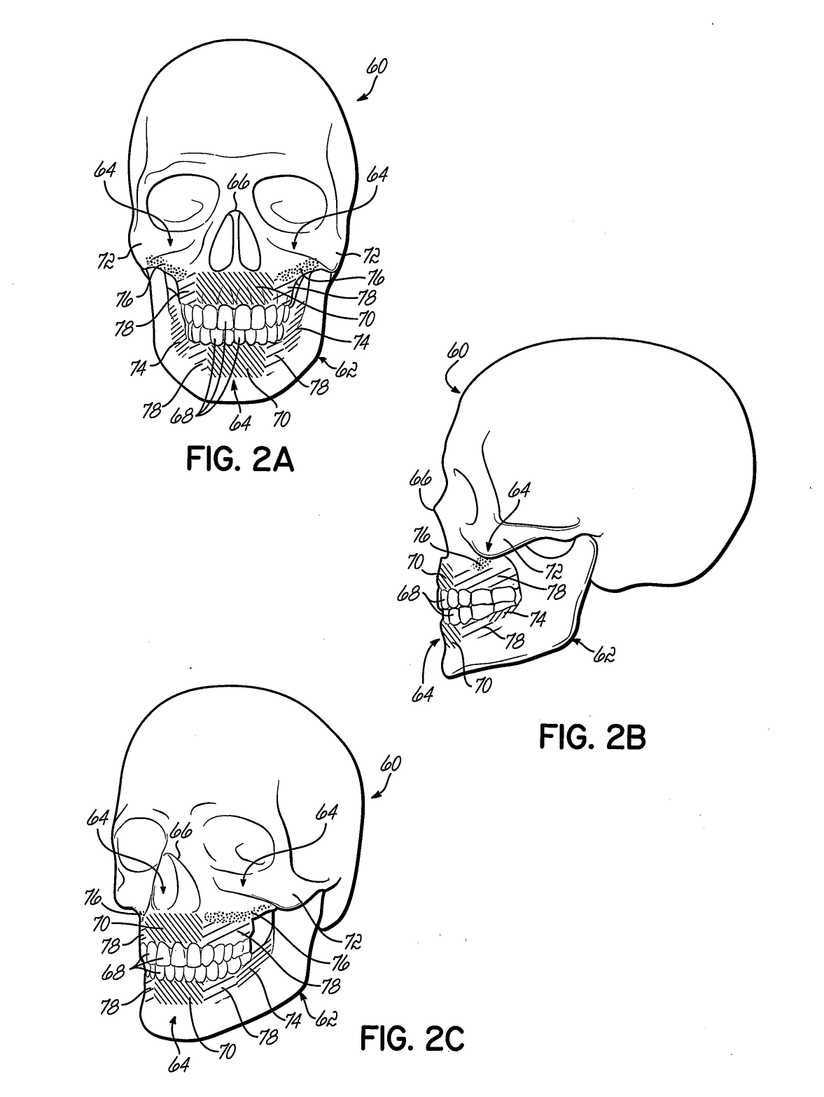

In the illustrated embodiment, the torque limiter 34 includes an annular dial 36 and a corresponding set of markings 38 located upon the outer surface 24 of the grip 18 proximal to the neck portion 22. The annular dial 36 has multiple positions for setting the limit at which the torque limiter will trip to prevent applying too much torque to the miniscrew being implanted. An indicator 39 on the dial 36 is aligned with one of the markings 38 to set the dial 36 to the desired marking 38, thereby setting the torque limiter 34 to the setting corresponding to the selected marking 38. The markings 38, in the illustrated embodiment, are colored areas to match a corresponding color on an orthodontic miniscrew for implantation. Alternate embodiments, may use other types of indicators to reference the different torque settings. For instance, numbers could replace the colored areas and correspond to a number on an orthodontic miniscrew to be implanted. Alternatively, other symbols, colors, or other indicators may be used. For example, if a color is used, like in the illustrated embodiment, a red orthodontic screw would have an implantation profile that matches a maximum torque that will be set by rotating the dial 36 to the marking 38 that is a red area. The organizational scheme is discussed in more detail in connection with FIGS. 2A-D and 3.

The driver 20 applies torque to the orthodontic miniscrew during implantation of the miniscrew into the jaw or skull of the patient. In some embodiments, the driver 20 has a friction or latch type head to attach to a screwdriver bit 40. Other embodiments connect the screwdriver bit 40 to the driver 20 by other methods, which upon reading this specification will be readily apparent to those skilled in this art. The driver 20 rotates both clockwise and counterclockwise to implant and remove orthodontic screws. The foot pedal 16 or the finger switch 30 controls the rotation of the driver 20 in the illustrated embodiment. Both the foot pedal 16 and the finger switch 30 have the ability to change the direction of rotation of the driver 20.

The neck portion 22 of the handle portion 12 connects the driver 20 to the grip 18. The neck portion 22 extends from and then angles away from the handle portion 12 in a contra angle configuration. The contra angle configuration facilitates ease of placement of the driver 20 into the patient's mouth. The neck portion 22 also includes a pressure display 42 for displaying the amount of pressure being applied to the orthodontic screw during implantation. The pressure can be sensed with a pressure sensor as is well known in the art, such as a pressure transducer. In the illustrated embodiment, the pressure display 42 has a plurality of lights 44 arranged in an array 46 for indicating the amount of pressure applied to the orthodontic screw, as measured for example by a pressure transducer (not shown). Applying more pressure to the orthodontic screw results in lighting more lights 44 in the array 46. Accordingly, the clinician can monitor the amount of pressure applied to the orthodontic screw ensuring that damage to the screw, the bone, or both does not occur during implantation.

The charging base 14 receives the handle portion 12 inside of a dock 48 and charges the power source located in the handle portion 12. The charging base 14 includes controls 50 for controlling the charging base 14, such as turning it on or off and to control other operating parameters of the driver device 10. In the illustrated embodiment, the charging base 14 includes an antenna 52 for wireless communication with the foot pedal 16. The antenna 52 may receive signals from the foot pedal 16 corresponding to the amount of torque that the driver 16 should apply and the rotational direction of application, which signals the charging base 14 can then communicate to the driver device 10. In the illustrated embodiment, these signals are communicated wirelessly to the driver device 10 via a suitable wireless system, such as a short-range wireless system that complies with the Bluetooth specification. In the illustrated embodiment, the charging base 14 connects to the foot pedal 16 providing power for the operation of the foot pedal 16. In this embodiment, either or both the charging base 14 and/or the foot pedal 10 may have a cord connection to an external power source, such as an electrical outlet. Other embodiments could have the foot pedal 16 powered by batteries or electronically plugged in separate from the charging base 14 to name a few examples.

In the illustrated embodiment, the foot pedal 16 or the finger switch 30 turns on and controls the rotation direction of the driver 20. Other embodiments may only use the foot pedal 16 or the finger switch 30 to control the rotation of the driver 20 and eliminate the other or assign different functions to the foot pedal 16 or finger switch 30. The foot pedal 16 has a first pedal 54 constructed and arranged for deflection by the clinician's foot. The first pedal 54 causes the driver 16 on the handle portion 12 to rotate clockwise. Similarly, the foot pedal 16 has a second pedal 56 constructed and arranged for deflection by the clinician's foot. The second pedal 56 causes the driver 20 to rotate counterclockwise. Accordingly, the clinician can deflect the pedals 54, 56 to rotate the driver 20 to implant or remove the orthodontic screw. The foot pedal 16 facilitates freeing the clinician's hands allowing one hand to open and work with the patient's mouth and the other hand to manipulate the handle portion 12. The foot pedal 16 therefore increases the ease of use. The foot pedal 16 also has an antenna 58 in the illustrated embodiment for facilitating wireless communication with the charging base 14 and/or the driver device via a wireless communication system. One non-limiting example of such a system is one that meets the Bluetooth specification. Other embodiments could have the foot pedal 16 and the charging base 14 communicating via an alternate method readily apparent to those skilled in this art, such as via a cable connection. It may be useful to have a single cable connection between the foot pedal 16 and the charging base 14 which carries both power and communication signals.

Referring now to FIGS. 2A-2D, a human skull 60 and jaw 62 is divided into a plurality of zones 64 to indicate the regions for a specific type of orthodontic screw. For instance, directly underneath the nose 66 and the central teeth 68 are blue zones 70 designed to receive a blue orthodontic screw. The cheek areas 72 include orange zones 74 and green zones 76, each designed to receive an orange and green screw, respectively. Positioned between the blue zones 70 and the orange and green zones 74, 76, are a pair of yellow zones 78 for receiving a yellow screw. FIG. 2D illustrates the palatal region. A blue zone 70 is located in the center of the palatal region and is surrounded on both sides with yellow zones 78. Upon reading this specification, those skilled in the art recognize that other indicators besides colors may be used in alternate embodiments.

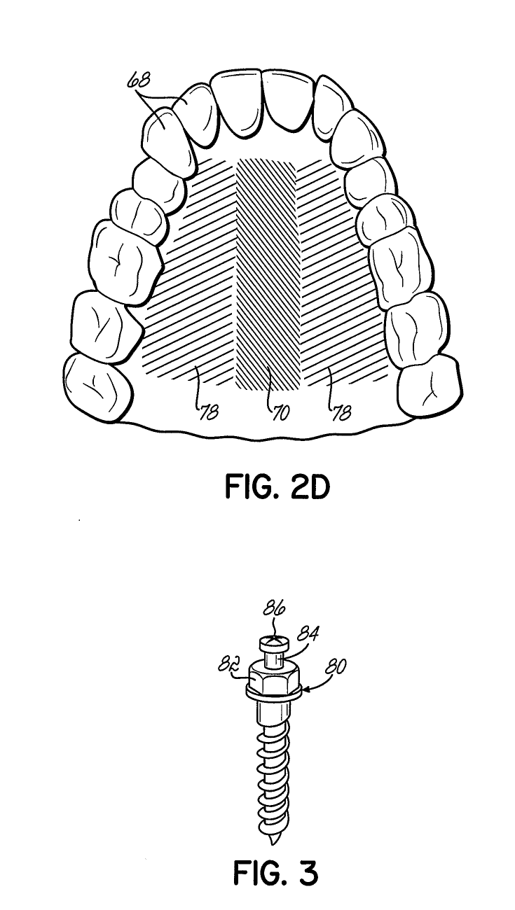

Referring now to FIG. 3, an orthodontic screw 80 for use with the driver device 10 is disclosed. The blue, orange, green, and yellow screws that would be used to match the zones 70, 74, 76, 78 have properties of dimension, etc. that suit the parameters of the respective zones 70, 74, 76, 78 matching their colors. In the illustrated embodiment, the screw 80 is an orthodontic screw having a hexagonally shaped head 82 and including a protruding cylindrical section 84 having grooves 86 for mating with a Phillips head driver. Accordingly, torque can be applied using a driver that fits around the hexagonally shaped head 82 or a driver having a Phillips head bit.

In use, the driver 10 enables implantation of the orthodontic screw 80 without damage to either the screw or the bone. Selection of the orthodontic screw 80 relates to the zones 64 the clinician chooses to implant. Indicators on the screw 80, such as color, inform the clinician of the proper indicator on the torque limiter dial 36 and that the screws 80 are appropriate for the chosen zones 64. The clinician sets the indicator 39 on the torque limiter dial 36 to align with the colored markings 38 on the handle portion 12. The clinician then places the orthodontic miniscrew 80 onto the driver bit 40 and then aligns the driver 20 and bit 40 with the one of the zones 64 into which the orthodontic miniscrew 80 will be implanted. The clinician then deflects one of the pedals 54, 56 on the foot pedal 16 or moves the finger switch 30 and the driver 20 begins to rotate implanting the orthodontic miniscrew 80 into the jaw 62 or skull 60 of the patient. The clinician monitors the pressure display 40 to determine if the amount of pressure applied during implantation is satisfactory. The torque limiter dial 36 prevents the torque from becoming excessive and potentially damaging the orthodontic screw 80 or the bone. The driver 20 also has a governor (not shown) for preventing the driver 20 from rotating at an excessive speed. The driver 20 therefore rotates the orthodontic miniscrew 80 readily implanting it into the jaw 62 or skull 60 of the patient at the desired location. In one embodiment, the driver 20 rotates at a single speed when it is turned on, which speed is set by the governor. In other embodiments, the driver may have a variable speed control with the maximum speed being set by the governor. The rotation of the driver 20 may also be reversed to facilitate withdrawal of the orthodontic miniscrew 80 at a later time once the orthodontic work has been performed.

While the present invention has been illustrated by description of various embodiments and while these embodiments have been described in considerable detail, it is not the intention of the applicant to restrict or in any way limit the scope of the claims to such detail. For example, indicia or indicators other than color may be advantageously utilized to accomplish the purposes of the invention. Additional advantages and modifications will readily appear to those skilled in the art. The invention in its broader aspect is, therefore, not limited to the specific details, representative system, apparatus, and method, and illustrative example shown and described. Accordingly, departures may be made from such details without departing from the spirit or scope of the applicant's general inventive concept.

What is claimed is:

1. A device for implanting an orthodontic temporary anchorage miniscrew into a bone in a patient comprising:
a handle portion constructed and arranged for handling with a human hand, the handle portion including one or more displays for providing feedback concerning the operation of the device and a plurality of controls to control operation of the device, the handle portion further including a driver that mates to a miniscrew and rotates it for implanting the miniscrew into the patient.

2. The device of claim 1 further including a foot pedal operatively coupled to the handle portion and including controls for controlling the operation of the driver.

3. The device of claim 2 wherein the foot pedal is operable to select the direction of the rotation of the driver.

4. The device of claim 2 wherein the handle portion is operatively coupled to the foot pedal through a wireless connection.

5. The device of claim 1 wherein the one or more displays include a display to provide feedback on the amount of pressure the driver applies to the miniscrew during implantation of the miniscrew into the patient.

6. The device of claim 5 wherein the pressure feedback is provided based on the output from a pressure sensor.

7. The device of claim 6 wherein said pressure sensor is a pressure transducer.

8. The device of claim 1 wherein the handle portion further includes a torque limiter to prevent the torque applied to the miniscrew from exceeding a predetermined maximum threshold.

9. The device of claim 8 wherein the torque limiter comprises a dial having a plurality of different indicia wherein each one of the plurality of dial indicia corresponds with a torque output for a miniscrew having an indicium corresponding to the one of the plurality of dial indicia.

10. The device of claim 9 wherein the indicia are colors.

11. The device of claim 8 wherein the torque limiter adjusts to the proper torque automatically.

12. The device of claim 1 wherein the handle portion further including revolutions per minute governor.

13. The device of claim 1 wherein the handle portion is sterilizable.

14. The device of claim 1 wherein the handle portion includes a finger switch that controls the rotation of the driver.

15. A method for implanting an orthodontic temporary anchoring miniscrew into a bone of a patient comprising:
obtaining a driver device for implanting a miniscrew into a bone of a patient;
setting a maximum level of torque for application by the device driver to the miniscrew using a torque limiter;
implanting the miniscrew into the bone of the patient using the driver device; and
monitoring a pressure applied to the miniscrew during the implanting of the miniscrew.

16. The method of claim 15 further comprising limiting the amount of revolutions per minute applied to the miniscrew by the driver device using a governor.

17. The method of claim 15 wherein the pressure applied to the miniscrew is displayed during the implanting of the miniscrew.

18. The method of claim 15 wherein the maximum level of torque for application to the miniscrew corresponds to a marking on the miniscrew.

19. A device for implanting an orthodontic miniscrew comprising:
a driver having a torque limiting function with a plurality of predetermined torque outputs each associated with an indicator selected from a plurality of indicators; and
a plurality of orthodontic miniscrews each having a distinct indicator corresponding to one of the plurality of indicators associated with the predetermined torque outputs, wherein the torque output of the driver for a certain indicator matches a selected torque profile for a miniscrew having a corresponding indicator.

20. The device of claim 19 wherein the indicators comprise colors.

21. A system for organizing orthodontic miniscrews for insertion into a bone of a patient comprising:
a first plurality of miniscrews, each having a first indicator;
a second plurality of miniscrews, each having a second indicator;
wherein the first indicator and the second indicator are correlated to predetermined zones of the jaw and skull.

22. The system of claim 21 wherein the correlation of said indicators to predetermined zones of the jaw and skull is based on at least one physiological property of the jaw and skull selected from the group of bone density, covering tissue type and covering tissue thickness.

23. The system of claim 21 wherein the correlation of said indicators to predetermined zones of the jaw and skull is based on at least one physical feature of a miniscrew selected from the group of physical features comprising: screw length, screw diameter, screw head shape, length of transmucosal collar of the screw, cutting flutes or threads, screw thread pitch, screw thread count, screw thread angulation, screw head height of emergence, screw surface treatments and screw surface coatings.

24. The system of claim 21 wherein the correlation of said indicators to predetermined zones of the jaw and skull is based on at least one physiological property of the jaw and skull selected from the group of bone density, covering tissue type and covering tissue thickness and at least one physical feature of a miniscrew selected from the group of physical features comprising: screw length, screw diameter, screw head shape, length of transmucosal collar of the screw, cutting flutes or threads, screw thread pitch, screw thread count, screw thread angulation, screw head height of emergence, screw surface treatments and screw surface coatings.

25. The system of claim 21 wherein said indicators are color indicators.

26. The system of claim 22 wherein said indicators are color indicators.

27. The system of claim 23 wherein said indicators are color indicators.

28. The system of claim 24 wherein said indicators are color indicators.

29. A driver device for inserting orthodontic miniscrews into the bone of a patient comprising:
a driver for connecting to and rotating the orthodontic miniscrew;
a handle portion constructed and arranged for gripping by a human hand;
a light array placed along the handle portion, wherein the light array responds to the level of pressure applied to the orthodontic miniscrew by the driver;
a dial placed along the handle portion, wherein adjustment of the dial limits the maximum amount of torque applied to the orthodontic miniscrew by the driver;
a controller for controlling the revolutions per minute of the driver; and
a finger switch operatively coupled to the handle portion at least controlling the direction of rotation of the driver.

30. The driver device of claim 29 wherein the driver device is sterilizable.

31. The driver device of claim 29 wherein the controller comprises a foot pedal.

32. The driver device of claim 29 wherein the controller comprises a finger operated device.

33. The driver device of claim 29 wherein the dial includes a plurality of indicators, each of which correlates with an amount of torque appropriate for a type of orthodontic miniscrew and also correlates with a designated indicator on the type of orthodontic miniscrews for which the amount of torque is appropriate.

34. The driver device of claim 33 wherein the correlated indicators for the dial and the miniscrews are color indicators.

35. The driver device of claim 29 wherein the light array illuminates additional lights when additional pressure is applied.

36. A system for implanting orthodontic miniscrews in a bone of a patient comprising:
a first miniscrew corresponding to a first zone in the bone of the patient, the first miniscrew having a first indicator;
a second miniscrew corresponding to a second zone in the bone of the patient, the second miniscrew having a second indicator; and
a driver device for implanting the first and second miniscrews into the bone, the driver having a torque limiter for setting the torque during implantation and having indicators that correspond to the amount of torque needed for placing a miniscrew having an indicator corresponding to the torque indicator.

37. The system of claim 36 wherein the correlated indicators are color indicators.
